(19) United States
(12) Patent Application Publication
(10) Pub. No.: US 2016/0212195 A1
(43) Pub. Date: Jul. 21, 2016

(54) INFORMATION PROCESSING APPARATUS, INFORMATION PROCESSING METHOD, AND NON-TRANSITORY COMPUTER READABLE MEDIUM

(71) Applicant: FUJI XEROX CO., LTD., Tokyo (JP)

(72) Inventor: Kohei HASHIMOTO, Kanagawa (JP)

(73) Assignee: FUJI XEROX CO., LTD., Tokyo (JP)

(21) Appl. No.: 14/803,320

(22) Filed: Jul. 20, 2015

(30) Foreign Application Priority Data
Jan. 20, 2015 (JP) 2015-008420

(51) Int. Cl. H04L 29/08

(52) U.S. Cl. CPC H04L 67/06

(57) ABSTRACT

An information processing apparatus includes a first controller and a second controller. The first controller performs a process in accordance with a predetermined program. The second controller performs a process in accordance with a program different from the program for the first controller. The first controller transmits request data including information on a request for a predetermined process to the second controller. In a case where the request indicated by the request data received from the first controller is a request other than a request for acquisition of history information, the second controller transmits response data to the first controller, the response data including response information indicating a response to the request, and history information indicating an operation history obtained when the predetermined process for the request is performed.

### CROSS-REFERENCE TO RELATED APPLICATIONS

This application is based on and claims priority under 35 USC 119 from Japanese Patent Application No. 2015-008420 filed Jan. 20, 2015.

### BACKGROUND

### Technical Field

The present invention relates to an information processing apparatus, an information processing method, and a non-transitory computer readable medium.

### SUMMARY

According to an aspect of the invention, there is provided an information processing apparatus including a first controller and a second controller. The first controller performs a process in accordance with a predetermined program. The second controller performs a process in accordance with a program different from the program for the first controller. The first controller transmits request data including information on a request for a predetermined process to the second controller. In a case where the request indicated by the request data received from the first controller is a request other than a request for acquisition of history information, the second controller transmits response data to the first controller, the response data including response information indicating a response to the request, and history information indicating an operation history obtained when the predetermined process for the request is performed.

### BRIEF DESCRIPTION OF THE DRAWINGS

An exemplary embodiment of the present invention will be described in detail based on the following figures, wherein:

FIG. 1 is a diagram illustrating an example of an image forming system according to an exemplary embodiment of the present invention;

FIG. 2 is a block diagram illustrating a hardware configuration of an image forming apparatus according to the exemplary embodiment of the present invention;

FIG. 3 is a block diagram illustrating a functional configuration of the image forming apparatus according to the exemplary embodiment of the present invention;

FIG. 4 is a conceptual diagram illustrating an example of inter-OS communication performed in the case where the configuration of the exemplary embodiment of the present invention is not used;

FIGS. 5A and 5B are diagrams illustrating an example of a format of data transmitted and received in inter-OS communication according to the exemplary embodiment of the present invention;

FIGS. 6A and 6B are diagrams illustrating an example of return data in the case where the configuration of the exemplary embodiment of the present invention is not used;

FIG. 7 is a diagram illustrating an example of return data for a request for acquisition of log information according to the exemplary embodiment of the present invention;

FIGS. 8A and 8B are diagrams illustrating examples of return data according to the exemplary embodiment of the present invention in the case where log information is divided;

FIGS. 9A and 9B are diagrams illustrating an example of return data according to the exemplary embodiment of the present invention;

FIG. 10 is a conceptual diagram illustrating an example of inter-OS communication according to the exemplary embodiment of the present invention;

FIG. 11 is a flowchart illustrating a process performed by a general purpose OS according to the exemplary embodiment of the present invention;

FIG. 12 is a flowchart illustrating a process performed by an RTOS according to the exemplary embodiment of the present invention; and

FIG. 13 is a diagram illustrating an example of command data according to the exemplary embodiment of the present invention.

### DETAILED DESCRIPTION

In the following, an exemplary embodiment of the present invention will be described in detail with reference to the drawings.

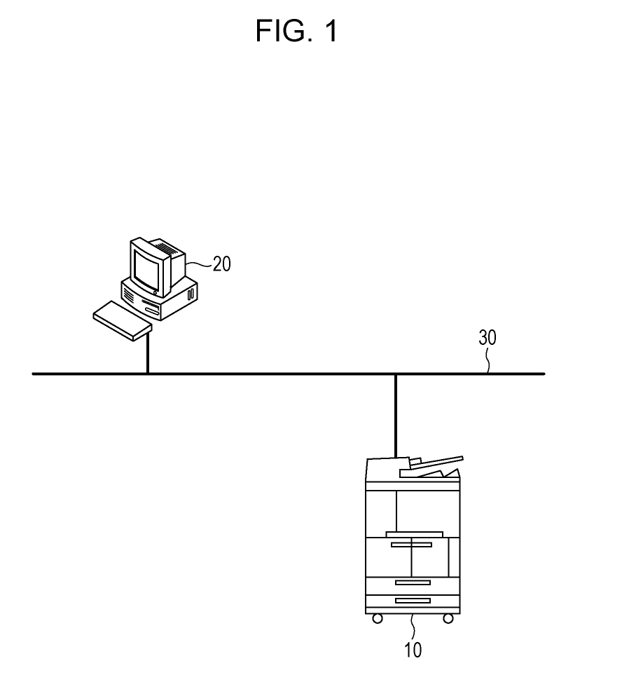

FIG. 1 is a diagram illustrating an example of an image forming system according to an exemplary embodiment of the present invention.

As illustrated in FIG. 1, an image forming apparatus 10 according to the present exemplary embodiment is connected to a terminal apparatus 20 via a network 30. The image forming apparatus 10 prints, on sheets, images represented by image data transmitted from the terminal apparatus 20 via the network 30 and images represented by image data transmitted from a reading apparatus that is not illustrated and that optically reads images such as a printer.

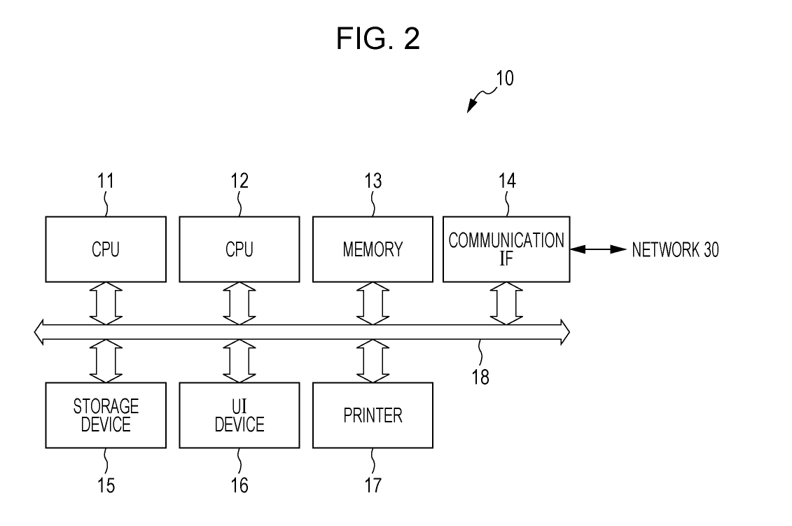

Next, a hardware configuration of the image forming apparatus 10 will be described in detail with reference to FIG. 2.

As illustrated in FIG. 2, the image forming apparatus 10 includes a CPU 11, a CPU 12, a memory 13, a communication interface (IF) 14, a storage device 15, a user interface (UI) device 16, and a printer 17. The communication IF 14 transmits and receives data to and from an external apparatus and the like via the network 30. Examples of the storage device 15 are a hard disk drive (HDD) and the like. The UI device 16 includes a touch panel or a liquid crystal display and a keyboard. These components are connected to one another via a control bus 18.

The CPU 11 (a first controller) controls an operation of the image forming apparatus 10 by performing a certain process in accordance with a control program stored in the memory 13 or the storage device 15. In addition, the CPU 12 (a second controller) controls an operation of the image forming apparatus 10 by performing a certain process in accordance with a control program stored in the memory 13 or the storage device 15 but different from the control program for the CPU 11. Note that, in the present exemplary embodiment, it has been described that the CPU 11 and the CPU 12 read and execute the control programs stored in the memory 13 or the storage device 15; however, the control programs may also be stored in storage mediums such as CD-ROMs and supplied to the CPU 11 and the CPU 12.

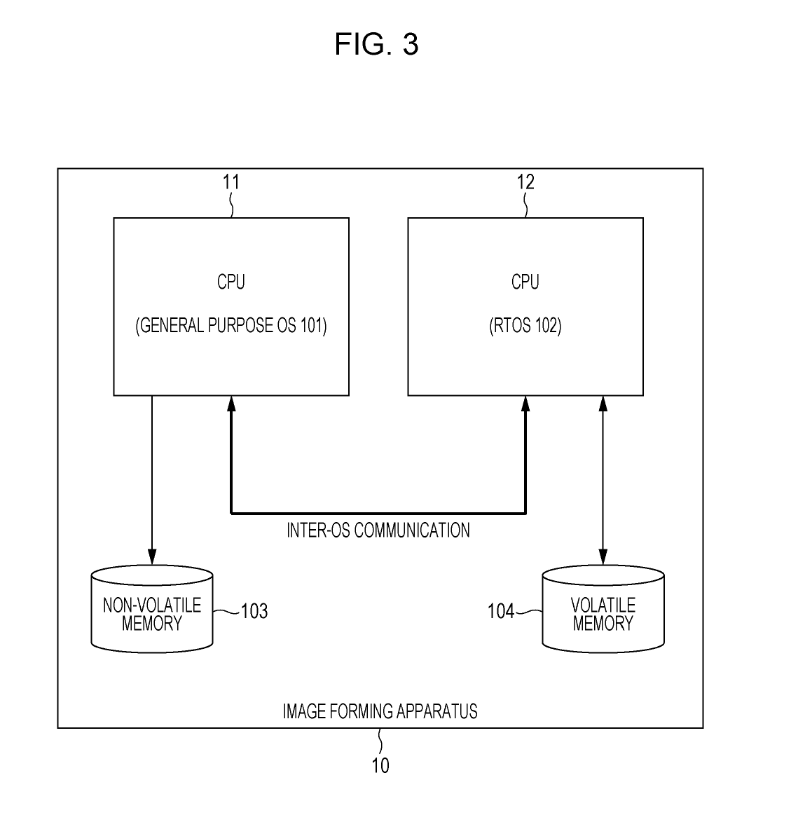

FIG. 3 is a block diagram illustrating a functional configuration of the image forming apparatus 10 realized by executing the above-described control programs.

In the image forming apparatus 10 according to the present exemplary embodiment, as illustrated in FIG. 3, a general purpose operating system (general purpose OS) 101 runs on the CPU 11, and a real-time operating system (RTOS) 102 runs on the CPU 12, which performs processing in accordance with the control program different from that for the CPU 11. In addition, as illustrated in FIG. 3, the image forming apparatus 10 includes a non-volatile memory 103 and a volatile memory 104. In addition, the general purpose OS 101 and the RTOS 102 communicate with each other through inter-OS communication in which transmission-reception of data in a predetermined format is performed.

The general purpose OS 101 is caused by the CPU 11 to control a non-time-critical process (a non-real time process) such as output of data to a user interface, the CPU 11 performing a process in accordance with a predetermined control program. In addition, the general purpose OS 101 transmits, as command data (request data), data in a predetermined format including information on a request for a predetermined process to the RTOS 102.

The RTOS 102 is caused by the CPU 12 to control a time-critical process (a real time process), in which a requested process is completed in a predetermined time, the CPU 12 performing a process in accordance with the control program different from that for the CPU 11. Examples of the requested process are control of an image reading device such as a scanner and control of an image output device such as a printer. In addition, in the case where the request indicated by the command data received from the general purpose OS 101 is a request other than a request for acquisition of log information (history information), the RTOS 102 transmits data in a predetermined format as return data (response data) to the general purpose OS 101. The data in the predetermined format includes return information (response information) indicating a response to the request, and log information indicating an operation history obtained when a process for the request is performed.

In addition, in the case where the RTOS 102 transmits return data to the general purpose OS 101, the RTOS 102 transmits response data structured such that log information is included in an unused region of the data in the predetermined format, the data including return information.

The non-volatile memory 103 does not require power supply to retain stored information and stores log information indicating an operation history acquired by the general purpose OS 101.

The volatile memory 104 requires power supply to retain stored information and temporarily stores log information obtained when a process is performed by the RTOS 102.

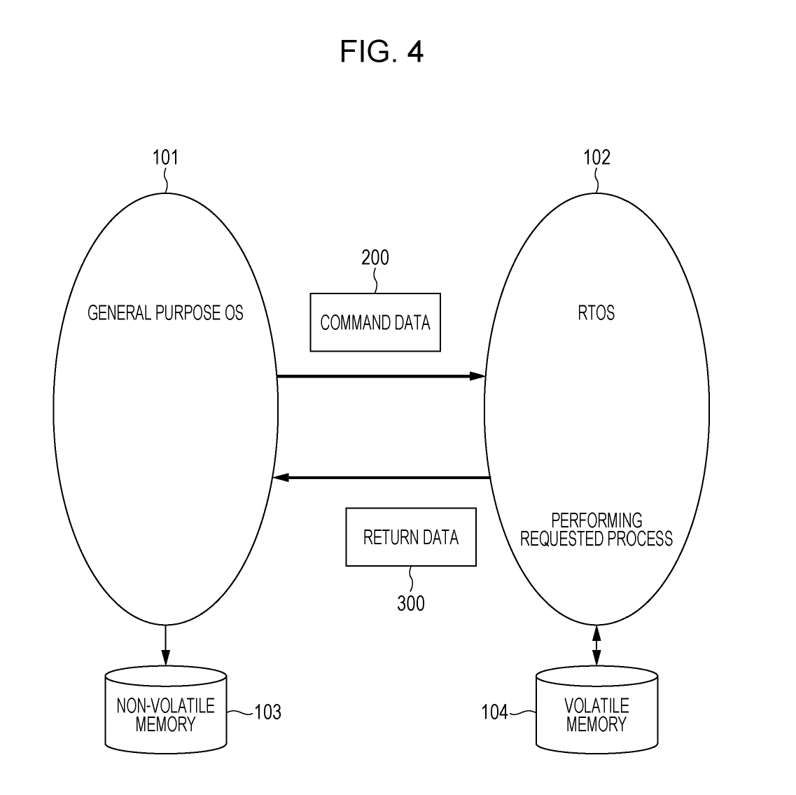

Next, first, in the case where the configuration of the exemplary embodiment of the present invention is not used, an example of general inter-OS communication performed when a request other than a request for acquisition of log information is issued will be described with reference to FIGS. 4 to 6.

FIG. 4 is a conceptual diagram illustrating an example of inter-OS communication performed between the general purpose OS 101 and the RTOS 102.

As illustrated in FIG. 4, the general purpose OS 101 issues a request for a process to the RTOS 102 by transmitting command data 200 to the RTOS 102. In the case where the RTOS 102 receives the command data 200, the RTOS 102 analyzes the command data 200 and performs the process requested by the general purpose OS 101. Then, the RTOS 102 stores log information obtained as a result of performing the requested process in the volatile memory 104. In addition, the RTOS 102 transmits return data 300 including return information indicating a response to the request to the general purpose OS 101.

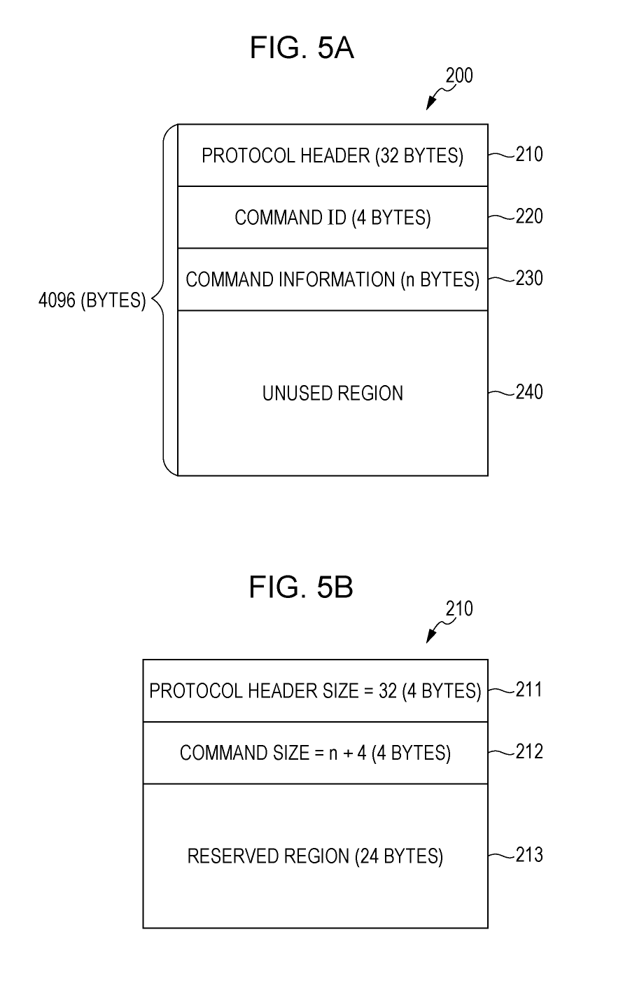

FIGS. 5A and 5B are diagrams illustrating an example of a format of data transmitted and received through inter-OS communication performed between the general purpose OS 101 and the RTOS 102.

As illustrated in FIG. 5A, in the case where the general purpose OS 101 issues a request for a process to the RTOS 102, the general purpose OS 101 generates data in a predetermined format including information on the request. For example, in the case where the general purpose OS 101 issues a print request for printing of images represented by print data transmitted from the terminal apparatus 20, the general purpose OS 101 generates, as the command data 200, data in a predetermined format including information on the print request. Specifically, as illustrated in FIG. 5A, the general purpose OS 101 generates 4096 byte data as the command data 200, the 4096 byte data including a protocol header 210 (32 bytes), a command ID 220 (4 bytes) indicating the print request, command information 230 (n bytes) indicating specific instructions of the print request, and an unused region 240.

In addition, as illustrated in FIG. 5B, the protocol header 210 includes a protocol header size 211 (4 bytes) indicating the size of the entirety of the protocol header 210, a command size 212 (4 bytes) indicating the total size of the command ID 220 and the command information 230, and a reserved region 213 (24 bytes). A reserved region is certain free space to which information may be added, in consideration of the case where an extension is installed in future.

In the example of the command data 200 illustrated in FIG. 5B, the size of the entirety of the protocol header 210 is illustrated as 32 bytes and the total size of the command ID 220 and the command information 230 is illustrated as n+4 bytes. Regarding FIG. 5B, a description will be made supposing that the remaining 24 byte region other than the protocol header size 211 and the command size 212 is the reserved region 213.

As illustrated in FIG. 5A, in the case where the protocol header 210 is 32 bytes, the command ID 220 is 4 bytes, and the command information 230 is n bytes in size in the command data 200, a 4096−(32+4+n) byte region is the unused region 240.

In the case where the RTOS 102 completes the process requested by the general purpose OS 101, the RTOS 102 transmits the return data 300 including return information indicating a response to the request to the general purpose OS 101. Here, the RTOS 102 generates the return data 300 using a format similar to that of the command data 200. Return information is, for example, information indicating a response to a request, the response including information indicating that a requested process is completed, information indicating that a requested process has failed, or the like.

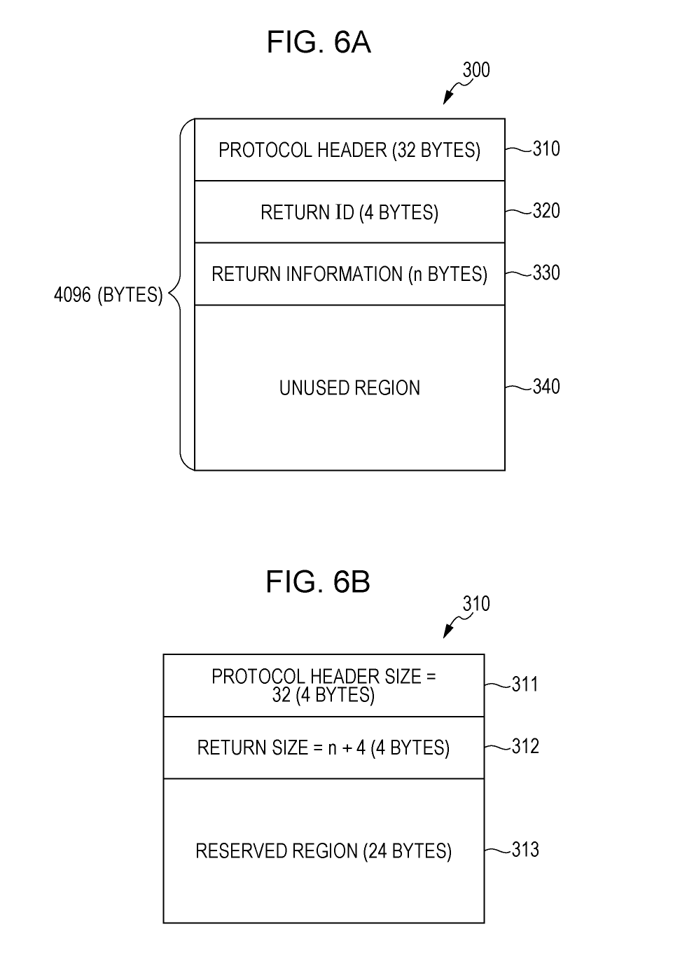

Specifically, as illustrated in FIG. 6A, the RTOS 102 generates 4096 byte data as the return data 300. The 4096 byte data includes a protocol header 310 (32 bytes), a return ID 320 (4 bytes), return information 330 (n bytes), and an unused region 340. The return ID 320 (4 bytes) indicates a response to a request. The return information 330 (n bytes) indicates information indicating that a requested process is completed, information indicating that a requested process has failed, or the like.

As illustrated in FIG. 6B, the protocol header 310 includes a protocol header size 311 (4 bytes) indicating the size of the entirety of the protocol header 310, a return size 312 (4 bytes) indicating the total size of the return ID 320 and the return information 330, and a reserved region 313 (24 bytes).

In the example of the return data 300 illustrated in FIG. 6B, the size of the entirety of the protocol header 310 is illustrated as 32 bytes, and the total size of the return ID 320 and the return information 330 is illustrated as n+4 bytes. Regarding FIG. 6B, a description will be made supposing that the remaining 24 byte region other than the protocol header size 311 and the return size 312 is the reserved region 313.

Similarly to the command data 200, as illustrated in FIG. 6A, in the case where the protocol header 310 is 32 bytes, the return ID 320 is 4 bytes, and the return information 330 is n bytes in size in the return data 300, a 4096−(32+4+n) byte region is the unused region 340.

In addition, in the case where the general purpose OS 101 acquires log information from the RTOS 102, the general purpose OS 101 issues a request for acquisition of log information to the RTOS 102. The RTOS 102 transmits, as return data, data including log information stored in the volatile memory 104 to the general purpose OS 101.

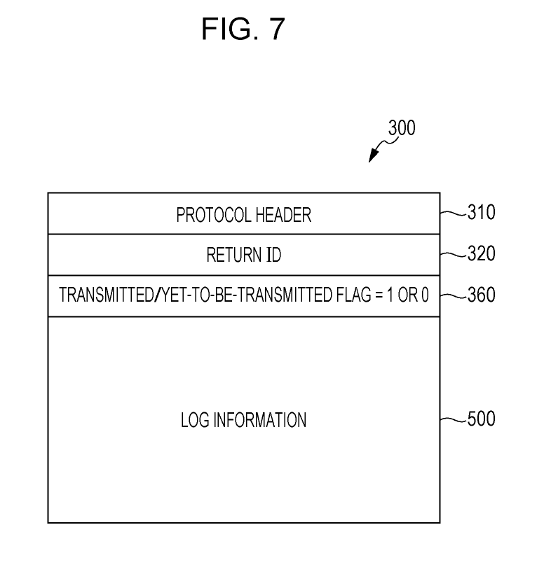

Specifically, in the case where the command data 200 including information on a request for acquisition of log information is received from the general purpose OS 101, the RTOS 102 generates data in a predetermined format as the return data 300 as illustrated in FIG. 7. The data in the predetermined format includes the protocol header 310, the return ID 320 indicating a response to the request for acquisition of log information, a transmitted/yet-to-be-transmitted flag 360, and log information 500.

In addition, in the case where the log information 500 does not fall within the data in the predetermined format in terms of size, the RTOS 102 divides the log information 500 into plural pieces and generates plural pieces of return data.

In the case where the transmitted/yet-to-be-transmitted flag is 1, it is indicated that after a certain piece of return data 300 has been received, another piece of return data including a piece of log information obtained by division is further to be transmitted from the RTOS 102. In the case where the transmitted/yet-to-be-transmitted flag is 0, it is indicated that after a certain piece of return data 300 has been received, another piece of return data including a piece of log information obtained by division is not transmitted.

Specifically, in the case where a request for acquisition of the log information 500 is issued from the general purpose OS 101 to the RTOS 102, first, the RTOS 102 acquires the log information 500 stored in the volatile memory 104. Then, return data including log information the size of which falls within the size of data in the predetermined format (4096 bytes) is generated.

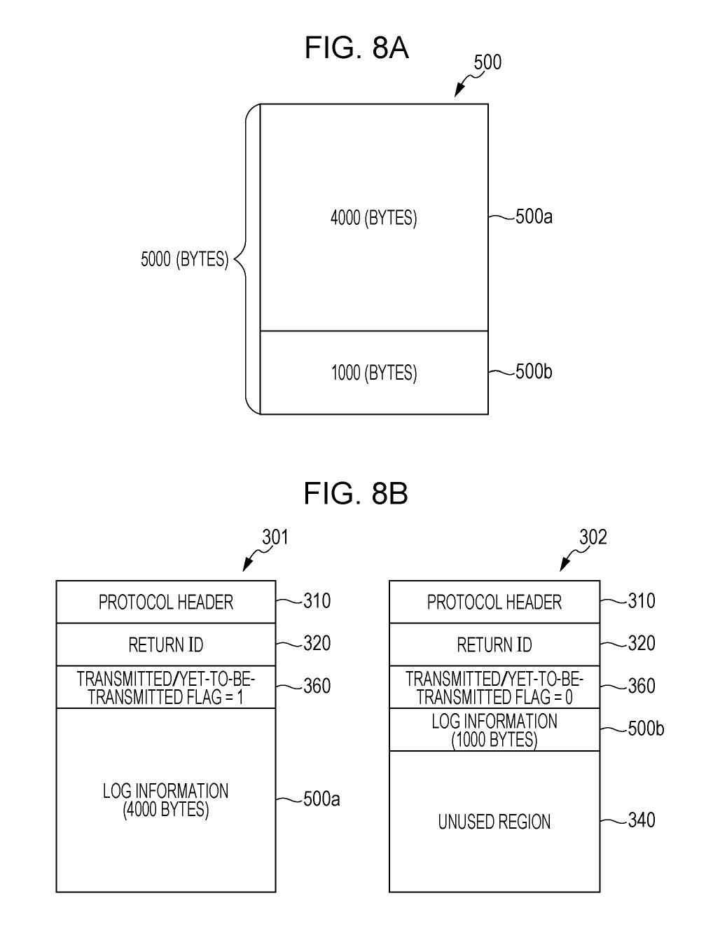

For example, in the case where the size of the log information 500 is 5000 bytes and 4000 byte log information may be included in data in the predetermined format, the log information 500 is divided into log information 500a, which is 4000 bytes in size, and log information 500b, which is 1000 bytes in size, as illustrated in FIG. 8A. Then, as illustrated in FIG. 8B, the RTOS 102 generates return data including the log information 500a as first return data 301, and generates return data including the log information 500b as second return data 302.

Next, after setting a transmitted/yet-to-be-transmitted flag of the first return data 301 to 1 and transmitting the first return data 301 to the general purpose OS 101, the RTOS 102 sets a transmitted/yet-to-be-transmitted flag of the second return data 302 to 0 and transmits the second return data 302 to the general purpose OS 101. Then, the general purpose OS 101 stores the log information included in the first return data 301 and the second return data 302, which have been received, in the non-volatile memory 103.

In the above-described method for acquiring log information, in the case where the total amount of the log information that has already been stored in the volatile memory 104 and the log information of the process performed by the RTOS 102 exceeds the capacity of the volatile memory 104 before a request for acquisition of log information is issued from the general purpose OS 101, at least a portion of the log information that has already been stored in the volatile memory 104 is overwritten with an excess of log information. Thus, the portion of the log information may not be acquired.

Next, an example of inter-OS communication will be described with reference to the drawings, the inter-OS communication being performed between the general purpose OS 101 and the RTOS 102 according to the exemplary embodiment of the present invention when a request other than a request for acquisition of log information is issued. Note that command data transmitted from the general purpose OS 101 is similar to the command data in the example of general inter-OS communication described above, and thus a description thereof will be omitted.

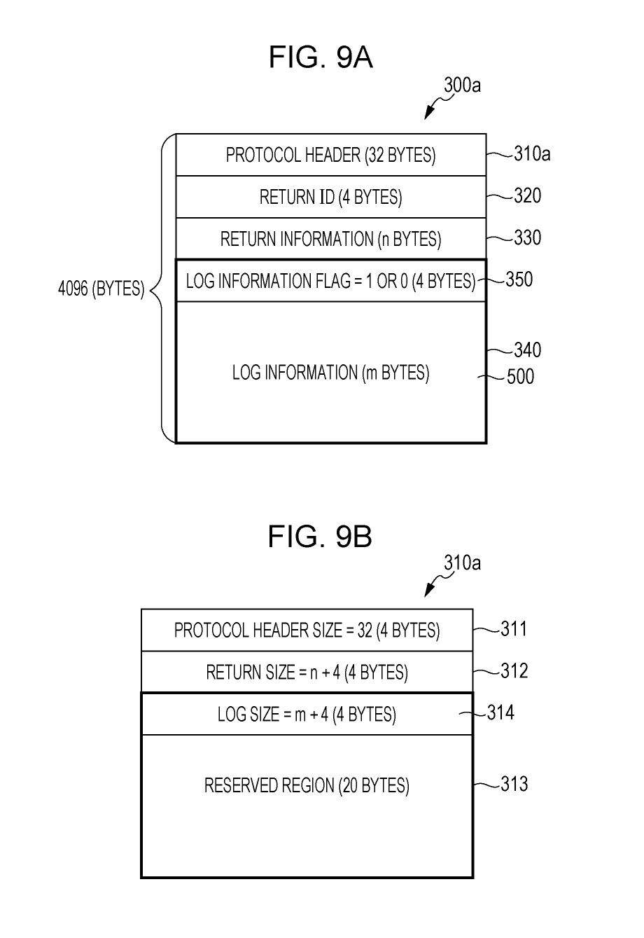

FIGS. 9A and 9B are diagrams illustrating an example of return data 300a according to the present exemplary embodiment.

As illustrated in FIGS. 9A and 9B, in the present exemplary embodiment, in the case where a request indicated by command data received from the general purpose OS 101 is a request other than a request for acquisition of log information, the RTOS 102 transmits data in a predetermined format as the return data 300a to the general purpose OS 101. The data in the predetermined format includes return information indicating a response to the request, and log information indicating an operation history obtained when a process for the request is performed.

Specifically, as illustrated in FIG. 9A, the RTOS 102 generates 4096 byte data as the return data 300a. The 4096 byte data includes a protocol header 310a (32 bytes), the return ID 320 (4 bytes), the return information 330 (n bytes), a log information flag 350 (4 bytes), and the log information 500 (m bytes). The return ID 320 indicates a response to the request. The return information 330 indicates the content of a requested process. The log information flag 350 indicates whether or not log information is included. The log information 500 indicates an operation history obtained when the process is performed by the RTOS 102. In the present exemplary embodiment, in the case where the RTOS 102 transmits the return data 300a to the general purpose OS 101, the RTOS 102 acquires the log information 500 stored in the volatile memory 104 when the process requested by the general purpose OS 101 is performed.

As illustrated in FIG. 9A, the return data 300a according to the present exemplary embodiment is structured such that the log information flag 350 and the log information 500 are included in the unused region 340 in the return data 300 illustrated in FIG. 6A. That is, compared with the return data 300 in the example of general inter-OS communication described above, the RTOS 102 according to the present exemplary embodiment generates the return data 300a such that the log information flag 350 and the log information 500 are stored in the unused region 340.

As illustrated in FIG. 9B, the protocol header 310a includes the protocol header size 311 (4 bytes), the return size 312 (4 bytes), a log size 314 (4 bytes), and the reserved region 313 in the present exemplary embodiment. The protocol header size 311 indicates the size of the entirety of the protocol header 310a. The return size 312 indicates the total size of the return ID 320 and the return information 330. The log size 314 indicates the total size of the log information 500 and the log information flag 350. In addition, in the present exemplary embodiment, as illustrated in FIG. 9B, the protocol header 310a is structured such that the log size 314 is included in the reserved region 313 of the protocol header 310 as illustrated in FIG. 6B as the example of general inter-OS communication described above.

In the example of the protocol header 310a illustrated in FIG. 9B, the size of the entirety of the protocol header 310a is illustrated as 32 bytes, the return size is illustrated as n+4 bytes, and the log size is illustrated as m+4 bytes.

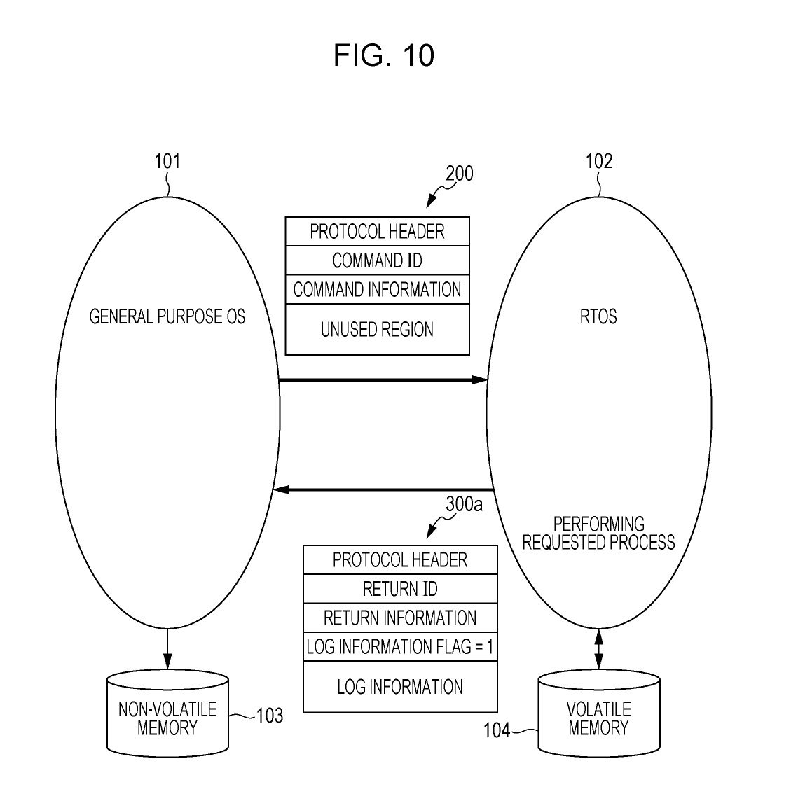

As illustrated in FIG. 10, in the case where the request indicated by the command data 200 received from the general purpose OS 101 is a request other than a request for acquisition of log information, the RTOS 102 performs the requested process and thereafter transmits the return data 300a, which has been described above, to the general purpose OS 101.

Then, the general purpose OS 101 analyzes the return data 300a received from the RTOS 102. In the case where the log information flag 350 included in the return data 300a is 1, the general purpose OS 101 determines that log information is included, acquires the log information 500 included in the return data 300a, and stores the log information 500 in the non-volatile memory 103. In the case where the log information flag 350 included in the return data 300a is 0, the general purpose OS 101 determines that log information is not included and performs a completion process based on the return information.

Note that in the present exemplary embodiment, it has been described that whether the return data 300a includes log information is determined in accordance with whether the log information flag 350 is 1 or 0; however, whether the return data 300a includes log information may also be determined in accordance with whether the log size 314, which is information indicating the size of log information included in the protocol header 310a, is greater than 0 bytes.

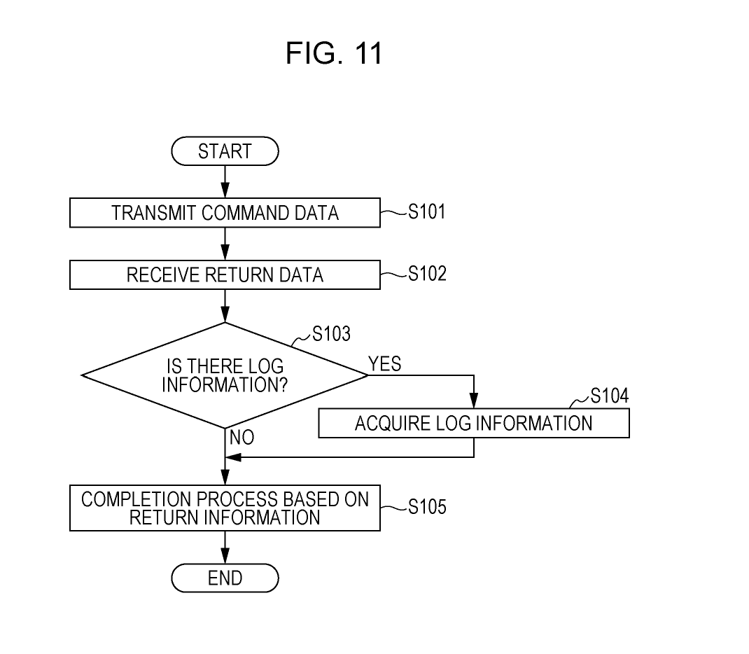

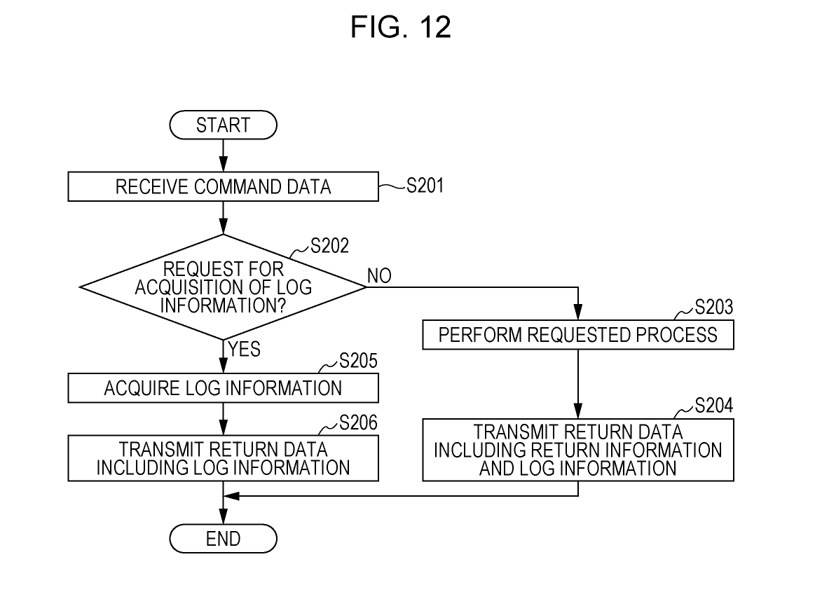

Next, a process performed by the image forming apparatus 10 according to the present exemplary embodiment will be described with reference to the flowcharts of FIG. 11 and FIG. 12.

First, a process performed by the general purpose OS 101 will be described with reference to the flowchart of FIG. 11.

First, the general purpose OS 101 transmits the command data 200 including information on a request for a predetermined process to the RTOS 102 (step S101). Next, the general purpose OS 101 receives the return data 300a from the RTOS 102 (step S102). Then, the general purpose OS 101 determines whether or not the received return data 300a includes log information (step S103). In the case where it is determined that the received return data 300a does not include log information (No in step S103), the process proceeds to step S105.

In the case where it is determined that the received return data 300a includes log information (Yes in step S103), the general purpose OS 101 acquires the log information 500 included in the return data 300a (step S104). In addition, the general purpose OS 101 stores the acquired log information 500 in the non-volatile memory 103.

Then, the general purpose OS 101 performs a completion process based on the return information 330 included in the return data 300a (step S105).

Next, a process performed by the RTOS 102 will be described with reference to the flowchart of FIG. 12.

First, the RTOS 102 receives the command data 200 from the general purpose OS 101 (step S201). Then, the RTOS 102 analyzes the received command data 200 and determines whether or not the received command data 200 indicates a request for acquisition of log information (step S202).

In the case where the received command data 200 indicates a request other than a request for acquisition of log information (No in step S202), the RTOS 102 performs a process requested by the general purpose OS 101 (step S203). Then, the RTOS 102 acquires the log information 500 of the performed process, and transmits the return data 300a including the return information 330 and the acquired log information 500, the return information 330 indicating a response to the request (step S204).

In the case where the received command data 200 indicates a request for acquisition of log information (Yes in step S202), the RTOS 102 acquires the log information 500 stored in the volatile memory 104 (step S205) and transmits the return data 300 including the acquired log information 500 (step S206).

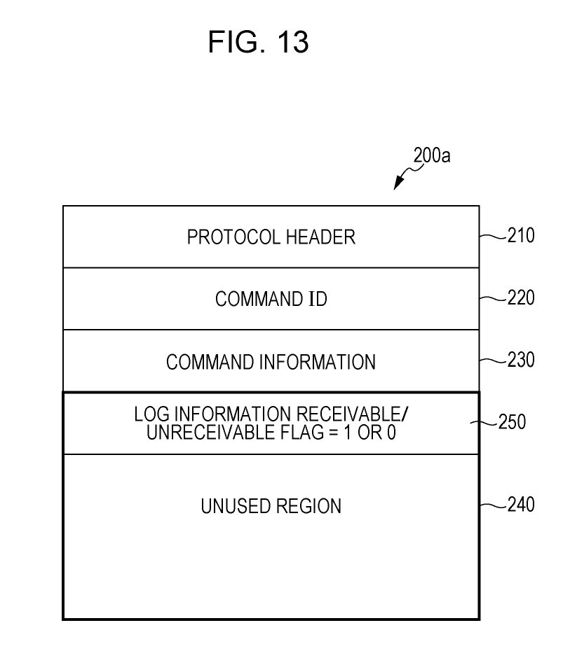

Note that it has been described that the general purpose OS 101 according to the present exemplary embodiment transmits the command data 200 including the protocol header 210, the command ID 220, the command information 230, and the unused region 240. However, as illustrated in FIG. 13, the general purpose OS 101 may also transmit command data 200a to the RTOS 102, the command data 200a being structured such that a log information receivable/unreceivable flag 250 is included in the unused region 240 of the command data 200. The log information receivable/unreceivable flag 250 indicates whether or not log information is receivable. For example, in the case where the request indicated by the command data 200a received from the general purpose OS 101 is a request other than a request for acquisition of log information and where the log information receivable/unreceivable flag 250 is 1, the RTOS 102 may transmit the return data 300a including return information and log information to the general purpose OS 101. In addition, in the case where the log information receivable/unreceivable flag 250 included in the command data 200a received from the general purpose OS 101 is 0, the RTOS 102 may transmit the return data 300, which does not include log information, to the general purpose OS 101.

In addition, examples have been described above in which the present exemplary embodiment is applied to the image forming apparatus 10; however, apparatuses to which the exemplary embodiment according to the present invention is applied are not limited to the image forming apparatus 10. The exemplary embodiment according to the present invention may be applied to any apparatus in which plural operating systems run. In particular, preferably, the exemplary embodiment according to the present invention is applied to an apparatus that uses both a real-time operating system and a general purpose operating system.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a first controller that performs a process in accordance with a predetermined program; and
a second controller that performs a process in accordance with a program different from the program for the first controller, wherein
the first controller transmits request data including information on a request for a predetermined process to the second controller, and
in a case where the request indicated by the request data received from the first controller is a request other than a request for acquisition of history information, the second controller transmits response data to the first controller, the response data including response information indicating a response to the request, and history information indicating an operation history obtained when the predetermined process for the request is performed.

2. The information processing apparatus according to claim 1, wherein
the response data is data in a predetermined format, and
the second controller transmits the response data to the first controller, the response data being structured such that the history information is included in an unused region of the data in the predetermined format including the response information.

3. The information processing apparatus according to claim 1, wherein
in a case where the first controller transmits the request data to the second controller, the first controller adds information indicating whether or not history information is receivable to the request data, and
in a case where the request indicated by the request data received from the first controller is a request other than a request for acquisition of history information and where the request data includes information indicating that history information is receivable, the second controller transmits the response data to the first controller.

4. The information processing apparatus according to claim 2, wherein
in a case where the first controller transmits the request data to the second controller, the first controller adds information indicating whether or not history information is receivable to the request data, and
in a case where the request indicated by the request data received from the first controller is a request other than a request for acquisition of history information and where the request data includes information indicating that history information is receivable, the second controller transmits the response data to the first controller.

5. An information processing method comprising:
transmitting request data including information on a request for a predetermined process; and
in a case where the request indicated by received request data is a request other than a request for acquisition of history information, transmitting response data including response information indicating a response to the request, and history information indicating an operation history obtained when the predetermined process for the request is performed.

6. A non-transitory computer readable medium storing a program causing a computer to execute a process, the process comprising:
transmitting request data including information on a request for a predetermined process; and
in a case where the request indicated by received request data is a request other than a request for acquisition of history information, transmitting response data including response information indicating a response to the request, and history information indicating an operation history obtained when the predetermined process for the request is performed.
